(19) United States
(12) Patent Application Publication
(10) Pub. No.: US 2015/0305571 A1
(43) Pub. Date: Oct. 29, 2015

(54) Food storage container and strainer device

(71) Applicants: Eric P. Hanson, Warren, NJ (US); Jennifer L. Grogan, Edison, NJ (US)

(72) Inventors: Eric P. Hanson, Warren, NJ (US); Jennifer L. Grogan, Edison, NJ (US)

(21) Appl. No.: 14/120,081

(22) Filed: Apr. 23, 2014

(51) Int. Cl. A47J 47/10; B65D 43/02; B65D 81/26; B65D 25/04

(52) U.S. Cl. CPC A47J 47/10; B65D 25/04; B65D 43/02; B65D 81/261

(57) ABSTRACT

A container with strainer divider is appointed to filter liquid from a food product to maintain freshness. The container has a bottom wall and side walls with securing means to secure the liquid strainer divider, which is formed with a main body portion terminating at a perimeter. The perimeter has a perimeter rim and is composed of a flat sheet with at least two opposing fold lines forming wall sections terminating at edges and a centrally located aperture. The perimeter rim is adapted to be received within the securing means. When inserted within the securing means, the sheet is forced to form a shallow cone shape with sloping side walls having a slope angle θ. In its non-compressed form, as when it is removed from the container, the liquid strainer divider is generally a flat sheet with fold lines and wall sections lying separated or non-overlapping in relation to one another.

### BACKGROUND OF THE INVENTION

1. Field of the Invention

The present invention relates to food storage and/or preparation containers; and more particularly, to a bowl/container or vessel that provides for removal or separation of liquids during storage and/or during food preparation.

2. Description of the Prior Art

Food storage is utilized extensively throughout society for distribution, reduction in waste of uneaten or leftover food, preservation, and healthy diet reasons. Oftentimes, when certain foods are stored the liquid in the food tends to pool at the bottom of the storage container. As the food sits in the container, the accumulation of pooled liquid, whether grease, oil, sauces, or water moisture, causes the food to lose freshness and become less edible. In some cases the food can become spoiled and unappetizing in a short period of time. Lettuce, salad, and vegetables in general can become wilted and began to rot earlier than would otherwise result in the absence of the liquid.

Several approaches heretofore known and/or utilized provide devices that provide a generally flat straining surface having a plurality of small holes for liquid to pass through. Various examples of generally flat strainer device apparatus with or without containments can be found in the following: U.S. Pat. No. 2,575,768 to Pearsall discloses a skimmer for skimming grease from the surface of soup and other liquid foods. U.S. Pat. No. 4,040,964 to Hegyi discloses an adjustable container strainer and handle including means for securing the same to various food containers such as cans and a handle to permit easier handling thereof. U.S. Pat. No. 4,680,117 to Freeman discloses a yogurt separator device having in one form a flat blank of filter mesh made of synthetic resin and having openings of from 200 microns to 400 microns in size. U.S. Pat. No. 4,560,475 to Kataoka discloses a filter assembly for providing a filtrate, such as coffee, having a sack of filter paper adhered to the back of a foldable support plate. U.S. Pat. No. 5,035,800 to Kopach discloses a strainer adapted to fit over an opening of a variety of food storage and preparation containers comprising a flexible matrix, a flexible cord which is slidably disposed within a conduit. U.S. Pat. No. 5,148,951 to Moure discloses a dispensing package for gel and semi-solid cleaning and skin care compositions. U.S. Design Pat. No. 5,219,006 to Bishop discloses a method and apparatus for a new and improved strainer funnel aid a cook in separating liquids from solids. U.S. Pat. No. 5,320,031 to Whitney discloses a food processing utensil for straining liquid from food packed in a liquid and for storage of the food product once the liquid is drained. U.S. Design Pat. No. 5373779 to Grusin discloses a yogurt cheese making device for separating the whey from yogurt having a strainer which receives the yogurt, the strainer having an open top, a bottom, a pair of opposing end walls, and a pair of opposing side walls. U.S. Patent App. Pub. No. 20120279930 to Iceton discloses a grease separator that includes a strainer bowl and funnel with a sieve in a lower surface. U.S. Patent Application Publication No. 20050205487 to Rogers discloses a combination colander bowl and container set including a colander bowl (a bowl with an integrated strainer and removable bottom plate that can be used as a colander when the bottom plate is removed), a cover that forms an air-tight seal with the bowl, and four snap-on lids that allow the cover, bowl and bottom plate to be used for food storage. U.S. Patent Application Publication No. 20130306646 to Cheng discloses a set of cooking vessels includes two or more fluid containing vessels that nest within each other for compact storage. Foreign Patent Pub. Nos. JPS6423080 and JPS63129281 to Yutaka disclose cooler/preservers for food to facilitate filtering and discharging of the fractions of food by providing a screen for filtering. Non-Patent Literature entitled “Pyrex Microwave And Oven Safe Food Container With Strainer” found at http://www.alibaba.com/productgs/1053847261/Pyrex_microwave_and_oven_safe_food. html discloses a microwave and oven safe food container with strainer. Non-Patent Literature entitled “Healthy Choice® Café Steamers” found at http://www.healthychoice.com/products/cafe-steamers discloses a microwave and oven safe food container with strainer. Non-Patent Literature “Marie Collanders® Fresh Favor Steamers” found at http://www.mariecallendersmeals.com/steamed-meals discloses a container wherein steam keeps sauce and food separated as the food cooks.

Other approaches heretofore known and/or utilized provide devices having conical or otherwise generally non-flat shaped strainers or filters. Examples can be found in: U.S. Pat. No. 2,456,912 to Burrows discloses a collapsible and adjustable filter and strainer. U.S. Pat. No. 3,861,975 to Hauslein discloses a filtering device including a filter receptacle and a filter element, the inner supporting faces of said filter receptacle and the outer supported faces of said filter element having the shape of identical equilateral triangles forming a pyramid having a quadratic cross-section. Non-Patent Literature entitled “Klip-It® Round Food Storage with Strainers” found at http://www.containerstore.com/shop/?productId=10030078 discloses a food storage container with a strainer that has a built-in handle for insertion and removal from the container.

Despite these and other food storage and straining devices and the like heretofore known and utilized, food storage problems remain paramount. Even with the removal of the majority of liquid from food, as the food sits during storage, more liquid begins to seep out from the food particles. Liquid includes not only water and other aqueous solutions, but oils and grease which coagulate over time. As a result, oftentimes the food product becomes unappetizing and/or the coagulation of the grease and oil on the food particles causes issues during reheating, as well as health issues in consuming fat. While several of these devices are adapted to remove the liquid from food, problems prevail as drainage is oftentimes hindered as food particles clog or cover the small apertures in the strainers. This is especially evident in flat type strainer constructs, which also have problems in removal from the container and proper volume placement of the bottom of the device in relation to the strainer. Even conical shaped or otherwise non-flat type strainers have problematic issues as these devices in general also include a plurality of apertures located on the side walls as well as the bottom wall of the structure. Again, food particles are prone to clogging or covering the apertures, resulting in liquid being trapped in the food.

Notwithstanding the efforts of prior art workers to construct food storage and straining devices and the like, there remains a need in the art for an apparatus and method adapted to help maintain the freshness of foods during storage, or during food preparation. Further, there is a need in the art for a device that provides for the function of storage and/or preparation of food in a manner that filters out or separates liquid from the food product, thereby enabling the food product to remain fresher for a longer period of time.

### SUMMARY OF THE INVENTION

The present invention provides a novel container with strainer divider adapted to help maintain the freshness of foods during storage, or during food preparation. Advantageously, the container with strainer divider helps maintain the freshness of food during storage, or during food preparation, by improving the separation of liquid from food. The subject container with strainer divider functions to filter out or separate liquid water, solutions and oils from the food product enabling the food product to remain fresher for a longer period of time and to remove unwanted fats in oil and grease, thereby making the food healthier overall.

In a first embodiment, a container with strainer divider is provided. The container with strainer divider comprises: (i) a container having a bottom wall and side walls; (ii) the side walls include a securing means that is adapted to fit and securely receive and house a liquid strainer divider; (iii) the liquid strainer divider formed having a main body portion terminating at a perimeter with a perimeter rim, the liquid strainer divider being composed of a flat sheet with at least two opposing fold lines forming wall sections and terminating at edges and to an aperture located centrally within the sheet; and (iv) the perimeter rim and perimeter of the main body portion of the liquid strainer divider is adapted to be received securely within the securing means of the container and when it is inserted within the securing means it is forced to form a shallow cone shape with sloping side walls having a slope angle θ. When the liquid strainer divider is in its non-compressed form, as when it is removed from the container, it is generally a flat sheet with fold lines and wall sections lying separated or non-overlapping in relation to one another. Conversely, when the liquid strainer divider is in its compressed form, as when it is inserted within the securing means within the container, it is forced to form the shallow cone shape with sloping side walls at the slope angle θ. The liquid strainer divider is adapted to separate liquid to the bottom wall of the container as it migrates down the sloping side walls through the centrally located aperture.

In another broad embodiment, a strainer divider is adapted to fit within a plethora of different containers. The strainer divider comprises: (i) a liquid strainer divider formed having a main body portion terminating at a perimeter with a perimeter rim, the liquid strainer divider being composed of a flat sheet with at least two opposing fold lines forming wall sections and terminating at edges and to an aperture located centrally within the sheet; (ii) the perimeter rim and perimeter of the main body portion of the liquid strainer divider is adapted to be received and abut against walls of a container and when it is inserted within the container the liquid strainer divider is forced to form a shallow cone shape with sloping side walls having a slope angle θ. The liquid strainer divider functions to separate liquid to the bottom of the container.

In another broad embodiment, a strainer divider is adapted to fit within a plethora of different containers. The strainer divider comprises: (i) a liquid strainer divider formed having a main body portion having a plurality of closely arranged apertures having small diameters, the body portion terminates at a perimeter with a perimeter rim; (ii) the perimeter rim and perimeter of the main body portion of the liquid strainer divider is adapted to be received and abut against walls of a container and the plurality of straining holes or apertures of the liquid strainer divider functions to separate liquid to the bottom wall of the container; (iii) the liquid strainer divider having removal means centrally located therein. The liquid strainer divider functions to separate liquid to the bottom of the container. In a preferred embodiment, a container is also provided for integration and removal of the strainer divider therein.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a is a view of another embodiment of the subject food storage container and/or strainer device generally fully assembled and ready for use;

FIG. 1b is a cross-sectional view of the container of FIG. 1a taken along line x-x;

FIG. 1c is a top view of the liquid strainer divider insert removed from the container in its non-compressed generally flat configuration;

FIG. 1d is a cross-sectional side view showing the liquid strainer divider insert housed in the container in its compressed cone shaped configuration;

FIG. 1e is a top view of the liquid strainer divider insert in its compressed cone shaped configuration as when it is housed in the container;

FIG. 1f is a bottom view of the liquid strainer divider insert in its compressed cone shaped configuration as when it is housed in the container;

FIG. 1g is a view of the container/vessel with the liquid strainer divider removed from the container showing the side walls and securing means.

FIG. 2a is a view of another embodiment of the subject food storage container and/or strainer device generally fully assembled and ready for use;

FIG. 2b is a top view of the liquid strainer divider insert removed from the container of FIG. 2a;

FIG. 3a is a view of a first embodiment of the subject food storage container and/or strainer device fully assembled and ready for use;

FIG. 3b is a view of an embodiment of the liquid strainer divider, herein shown as a grate or strainer, removed from the container of FIG. 3a;

FIG. 3c is a view of the container/vessel of FIG. 3a with the liquid strainer divider removed from the container showing the side walls and securing means; and

FIG. 4 is a view of another embodiment of the subject food storage container and/or strainer device; and

FIG. 5a is a view of another embodiment of the subject food storage container and/or strainer device generally fully assembled and ready for use;

FIG. 5b is a cross-sectional side view of the food storage container and/or strainer device shown in FIG. 5a;

FIG. 5c is a top view of the liquid strainer divider insert removed from the container of FIG. 5a.

### DETAILED DESCRIPTION OF THE INVENTION

The present invention provides a container with strainer divider appointed to filter liquid from a food product to maintain freshness. Food storage, particularly of fresh foods for example, can pose significant problems when liquid or oil remains in the food. As food several foods, for example salads, sit more water or liquid, or oil (i.e. from a ground meat dish) escapes and pools under the food. In just a short period of time the food can become soggy and wilted, and generally inedible and unappetizing. Oils coagulate and harden, providing an even less appealing food dish. Even still, if one were to stir or reheat the food mixture, the oil would become redistributed on the food, rendering an unhealthy meal. Removal of the liquid, including fats and oils during storage is therefore advantageous. While devices have been provided over the years to address various food storage problems, problems still prevail owing to insufficient drainage and removal and separation of the liquid. Oftentimes, drainage is mired because food particles clog or cover small apertures in the strainer device or liquid migration is not optimal. Flat type strainer constructs, for instance, are particularly prone to clogging and blockage problems, as well as liquid migration problems as liquid accumulates and beads within the strainer apertures during the refrigeration process. Even conical shaped or otherwise non-flat type strainers heretofore disclosed and utilized have problematic issues as these devices in general also include a plurality of apertures located within side walls as well as the bottom wall of the structure. Again, food particles are prone to clogging or covering the apertures, resulting in liquid being trapped in the food.

It has been surprisingly and unexpectedly found that a liquid strainer having a cone shaped body with smooth non-aperture side walls terminating to a central single aperture provides optimal drainage despite having less surface area of apertures. When the liquid strainer divider is in its non-compressed form, as when it is removed from the container, it is generally a flat sheet with fold lines and wall sections lying separated or non-overlapping in relation to one another. Conversely, when the liquid strainer divider is in its compressed form, as when it is inserted within the securing means within the container, it is forced to form the shallow cone shape with sloping side walls at the slope angle θ. The liquid strainer divider is adapted to separate liquid to the bottom wall of the container as it migrates down the sloping side walls through the centrally located aperture.

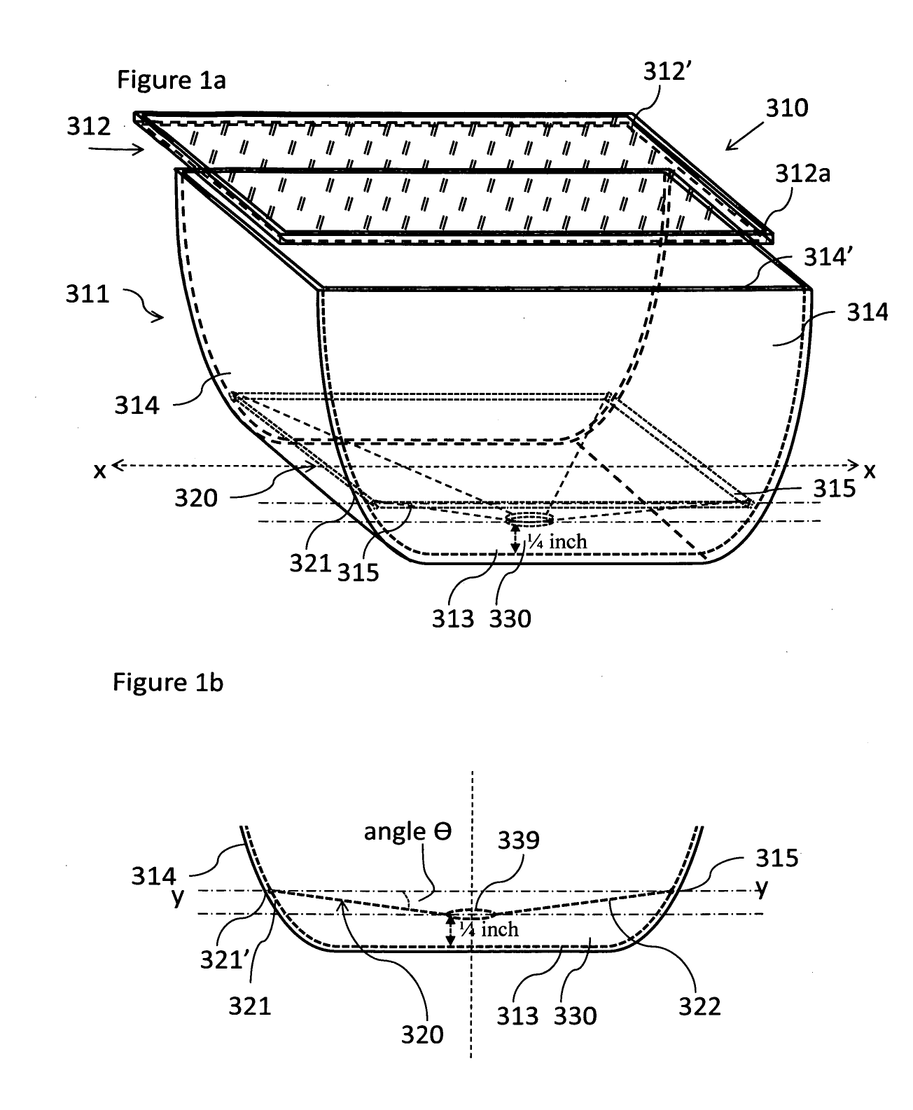

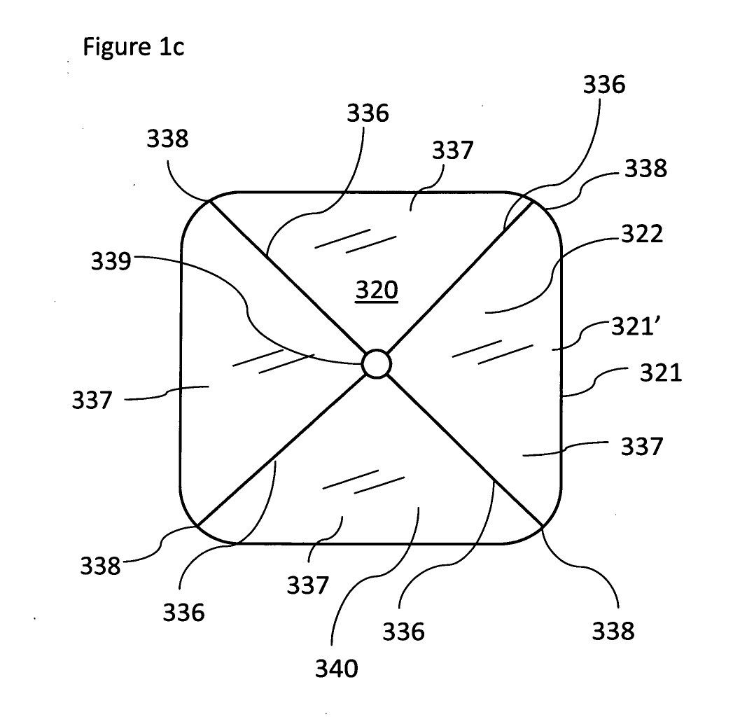

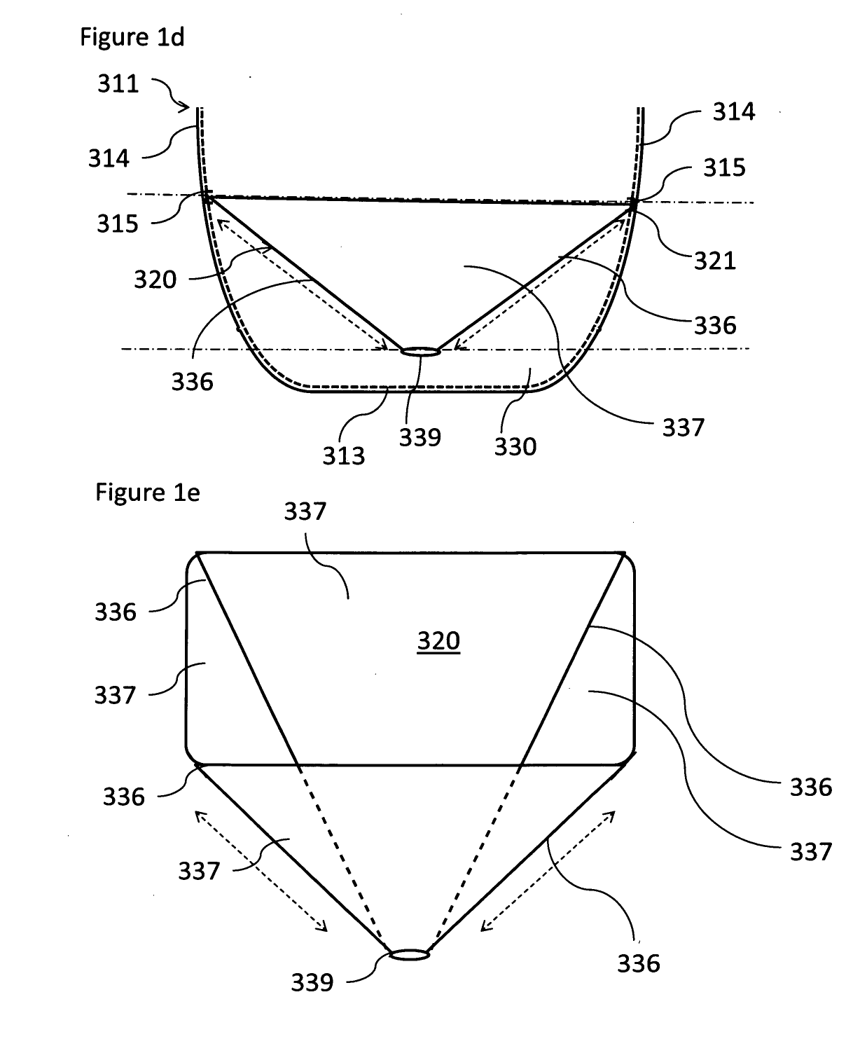

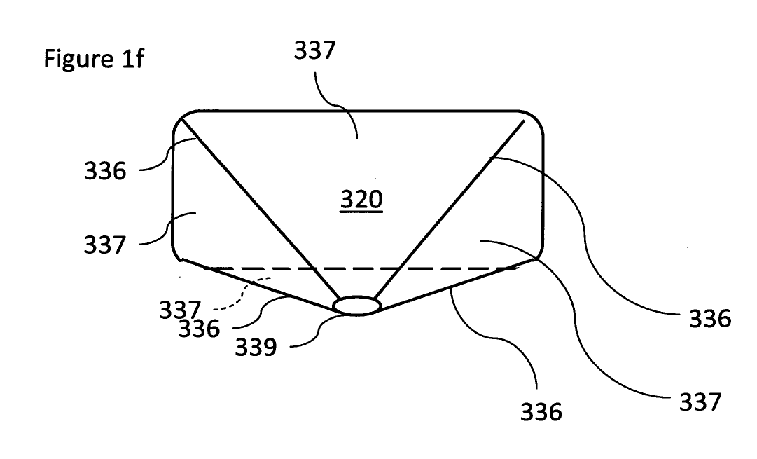

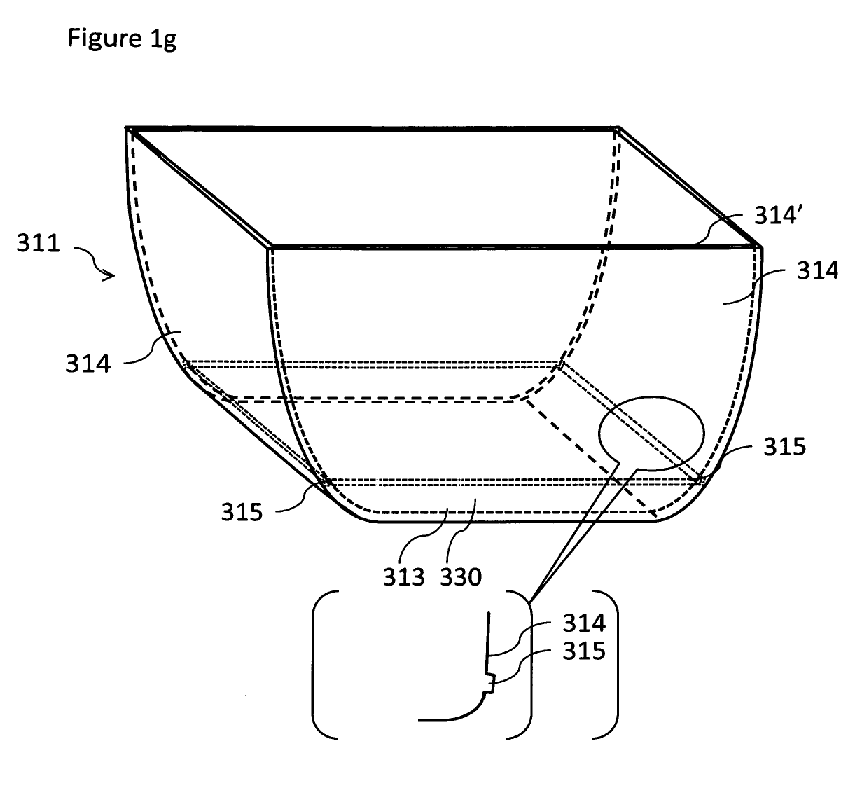

The subject container with strainer provides a novel apparatus and method adapted to help maintain the freshness of foods while they are stored, or during food preparation. Advantageously, the subject container with strainer provides the ability to store or prepare food in a manner that filters out or separates liquid from the food product, thereby enabling the food product to remain fresher for a longer period of time. FIGS. 1-4 illustrate various embodiments of the subject container with strainer apparatus and method of use thereof.

FIGS. 1a-1g illustrate another embodiment of the ‘Fresh Fit Vessel, shown generally at 310. In the embodiment shown, a liquid strainer divider insert 320 is shown constructed as a shallow cone shape with an opening on the bottom to permit liquid to migrate to the bottom of the container. The shallow cone shaped member is composed of a slippery plastic material, which allows liquid to move freely down and through the aperture at the center of the cone. FIG. 1a shows the container with strainer generally fully assembled and ready for use. FIG. 1b shows a cross-sectional view of the container of FIG. 1a taken along line x-x. FIG. 1c shows a top view of the liquid strainer divider insert 320 when it is removed from the container in its non-compressed generally flat configuration. FIG. 1d shows a cross-sectional side view showing the liquid strainer divider insert 320 housed in the container in its compressed cone shaped configuration. FIG. 1e shows a top view of the liquid strainer divider insert 320 in its compressed cone shaped configuration as when it is housed in the container. Figure if shows a bottom view of the liquid strainer divider insert 320 in its compressed cone shaped configuration as when it is housed in the container. FIG. 1g shows the container/vessel with the liquid strainer divider removed from the container showing the side walls and securing means.

Referring to FIGS. 1a-1g, the container with strainer 310 is generally formed as a container 311 with a lid 312. Lid 312 is appointed to seal container 311 and prevent leakage from the container 311. Container 311 is preferably a plastic container for food storage, and it can come in a plethora of different shapes and sizes. Herein container 311 is generally shown as a rectangular or square container. Container 311 is constructed with a bottom wall 313 and side walls 314. Side walls 314 terminate at a rim or top edge 314′ that includes a lip that is adapted to be snapped into a groove 312a within lid 312 for closing and sealing container 311. Side walls 314 include a securing means 315 that is adapted to fit and securingly receive and house a liquid strainer divider 320. Preferably, securing means 315 in side walls 314 is constructed as a groove in at least a portion of each of the side walls 314. More preferably, the groove extends along the interior perimeter of the side walls 314 as a continuous groove circumferentially running continuously along the entire side walls 314. The securing means 315/groove is formed as a notch or groove that is adapted to receive a rim 321 of the liquid strainer divider 320. This securing means 315/circumferentially extending groove is located approximately ¼ inch from the bottom wall 313 of container 311. It is noted that the height from the bottom wall 313 of the container 311 to the securing means 315/circumferentially extending groove may be adjusted depending on the volume of the container itself. That is to say, for smaller containers the distance may be less than ¼ inch, while for larger containers, the distance may be greater than ¼ inch, ranging instead from ¼ inch to 3 inches, for example.

A liquid strainer divider 320 is adapted to be removably received within container 311 by way of the securing means 315/circumferentially extending indenture. The liquid strainer divider 320 in this embodiment is formed with a main body portion 322 having a removal means 323 centrally located therein. The body portion 322 terminates at a perimeter 321′ with a perimeter rim 321. In the embodiment shown, the liquid strainer divider 320 is composed of a flexible sheet 335 that includes at least two opposing fold lines 336 forming wall sections 337 and terminating at edges 338 and to an aperture 339 located centrally within sheet 335. Preferably, there are at least four opposing fold lines 336 and visa vie four wall sections 337 as shown (see FIG. 1c for example), terminating at opposing edges 338 and aperture 339. As depicted in FIG. 1c, when liquid strainer divider 320 is in its non-compressed form, as when it is removed from container 311, it is generally a flat sheet with fold lines 336 and walls sections 337 laying separated or non-overlapping in relation to one another. Conversely, when the liquid strainer divider 320 is in its compressed form, as when it is inserted within the securing means 315/groove of container 311, it is forced to form a shallow cone shape with sloping side walls 338 having a slope angle θ ranging from about 10° to about 45° from line y (generally from securing means 315/indenture) [see FIGS. 1a-1b, 1d-1f]. As liquid strainer divider 320 is inserted within container 311 opposing fold lines 336 cause wall sections 337 to converge into the cone shape or converge into angled walls. In turn, the shallow cone-shape that results causes liquid to migrate down the wall sections 337 to aperture 339 to permit liquid to migrate to the bottom of the container 311.

The shallow cone shaped member is preferably composed of a slippery plastic material, which allows liquid to move freely down and through the aperture at the center of the cone. The liquid is then received and held in a bottom cavity 330 of container 311. For securement within the container, liquid strainer divider 320 includes a perimeter rim 321 and perimeter 321′ thereof are snapped and received securely and tightly fit within the securing means 315/circumferentially extending groove of container 311. Removal means 323 of strainer 320 is provided as a tab or finger hole/via aperture 339 may be used, wherein a user pulls upward thereon to remove or snap the strainer 320 from the securing means 315/circumferentially extending groove of the container for removal of the strainer 320 from the container 311. In another embodiment the removal means 323 may instead be pull tabs located on or near perimeter rim 321 and/or perimeter 321′. Preferably perimeter rim 321 and perimeter 321′ thereof are composed of a resilient yet flexible material so that the perimeter rim 321 and perimeter 321′ can be compressed and deformed to snap into/out of the securing means 315/circumferentially extending indenture. The main body portion 322 may be composed of the same material, or may be composed of a more rigid material. Materials contemplated include polymeric materials, rubber, and/silicone materials or combinations thereof. Lid 312 is preferably is aerated for circulation by way of at least one aeration aperture 312′, preferably there are a plurality of aeration apertures 312′ as illustrated in the figure.

The divider 320 results in a sloped removable drainage floor 340 with a hole/aperture 339 in the center. It is composed of a flexible plastic or silicone that when the sides or four wall sections are clipped into place within the container, the floor of the divider 320 depresses creating an angle for grease/oil/water/liquid to drain to the bottom of the container. The divider 320 floor is composed of a very slick plastic to allow easy drainage. Advantageously, the solid removable floor/divider 320, owing to its small central aperture, allows for the contents to be shaken without the unwanted drainage from returning to the food product located above the divider 320.

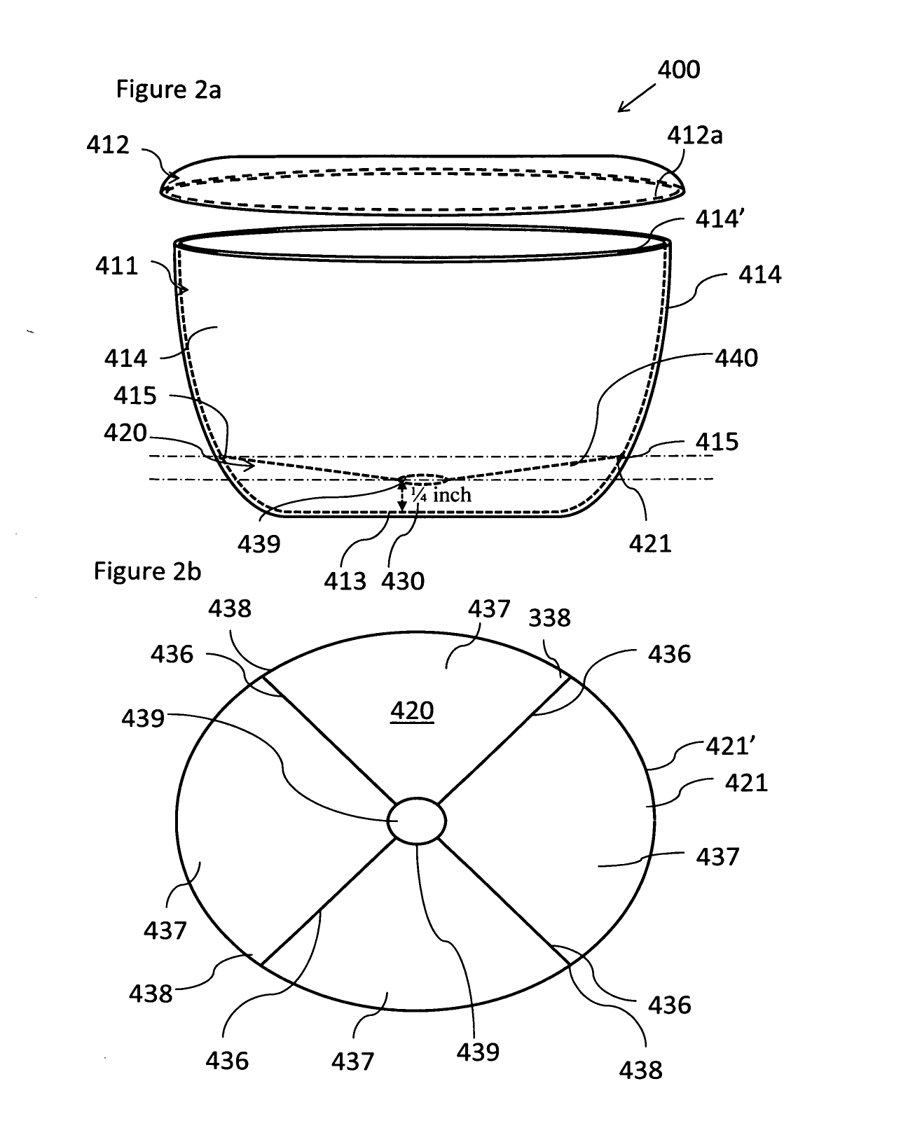

FIGS. 2a-2b illustrate the embodiment of the container with strainer shown generally in FIGS. 1a-1g, however wherein the container is constructed as a round or oval bowl, formed as a container 411 with a lid 412. Like the previous embodiment, container 411 is constructed having a bottom wall 413 and side walls 414 that terminate at a rim or top edge 415 including a lip or closure that is adapted to be snapped into a groove 412a within lid 412. Side walls 414 include a securing means 415 adapted to fit and securing receive and house a liquid strainer divider 420. Preferably, securing means 415 in side walls 414 is constructed as a groove in at least a portion of each of the side walls 414. More preferably, the groove extends along the interior perimeter of the side walls 414 as a continuous groove circumferentially running continuously along the entire side walls 414. The securing means 415/groove is formed as a notch or groove that is adapted to receive a rim 421 of the liquid strainer divider 420. A liquid strainer divider 420 is adapted to be removably received within container 411 by way of the securing means 415/circumferentially extending indenture. The liquid strainer divider 420 is formed as discussed above regarding FIGS. 1a-1g.

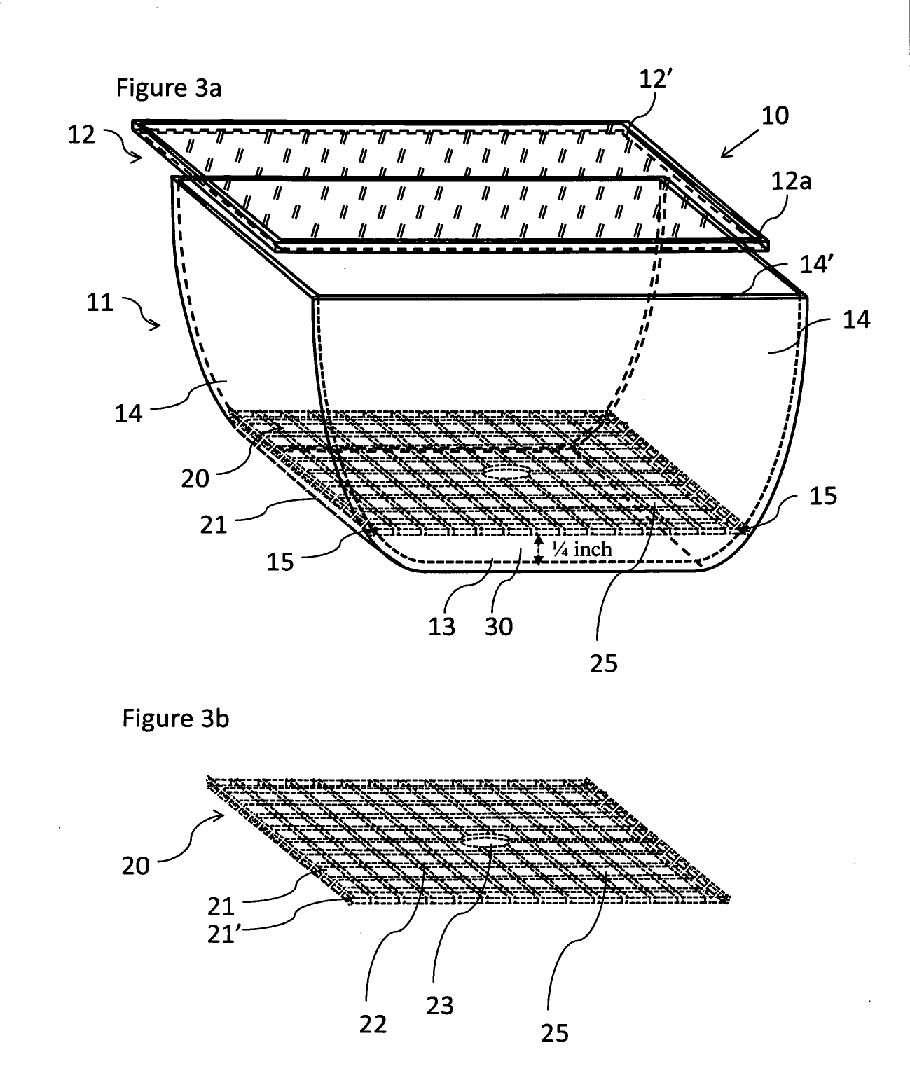

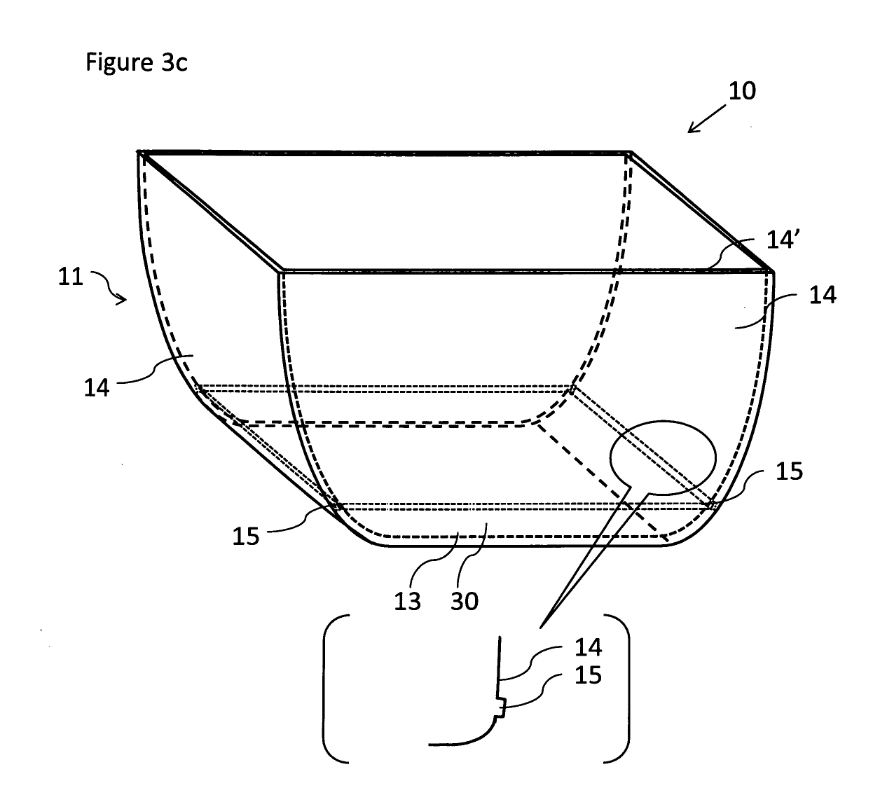

FIGS. 3a-3c illustrate an embodiment of the ‘Fresh Fit Vessel, shown generally at 10. FIG. 3a shows the container with strainer generally fully assembled and ready for use. FIG. 3b shows an embodiment of the liquid strainer divider, herein shown as a grate or strainer, removed from the container. FIG. 3c shows the container/vessel with the liquid strainer divider removed from the container showing the side walls and securing means. Referring to FIGS. 3a-3c, the container with strainer 10 is generally formed as a container 11 with a lid 12. Lid 12 is appointed to seal container 11 and prevent leakage from the container 11. Container 11 is preferably a plastic container for food storage, and it can come in a plethora of different shapes and sizes. Herein container 11 is generally shown as a rectangular or square container. Container 11 is constructed with a bottom wall 13 and side walls 14. Side walls 14 terminate at a rim or top edge 14′ that includes a lip that is adapted to be snapped into a groove 12a within lid 12 for closing and sealing container 11. Side walls 14 include a securing means 15 that is adapted to fit and securingly receive and house a liquid strainer divider 20. Preferably, securing means 15 in side walls 14 is constructed as a groove in at least a portion of each of the side walls 14. More preferably, the groove extends along the interior perimeter of the side walls 14 as a continuous groove circumferentially running continuously along the entire side walls 14. The securing means 15/groove is formed as a notch or groove that is adapted to receive a rim 21 of the liquid strainer divider 20. This securing means 15/circumferentially extending groove is located approximately ¼ inch from the bottom wall 13 of container 11. It is noted that the height from the bottom wall 13 of the container 11 to the securing means 15/circumferentially extending groove may be adjusted depending on the volume of the container itself. That is to say, for smaller containers the distance may be less than ¼ inch, while for larger containers, the distance may be greater than ¼ inch, ranging instead from ¼ inch to 3 inches for example.

The liquid strainer divider, herein shown as a grate or strainer, shown at 20 is adapted to be removably received within container 11 by way of the securing means 15/circumferentially extending indenture. The liquid strainer divider, or strainer 20 in this embodiment, is formed having a main body portion 22 with a removal means 23 centrally located therein, with the body portion 22 terminating at a perimeter 21′ with a perimeter rim 21. Perimeter rim 21 and perimeter 21′ thereof are snapped and received securely and tightly fit within the securing means 15/circumferentially extending groove of container 11. Removal means 23 of strainer 20 is provided as a tab or finger hole wherein a user pulls upward thereon to remove or snap the strainer 20 from the securing means 15/circumferentially extending groove of the container for removal of the strainer 20 from the container 11. In another embodiment the removal means 23 may instead be pull tabs located on or near perimeter rim 21 and/or perimeter 21′. Preferably perimeter rim 21 and perimeter 21′ thereof are composed of a resilient yet flexible material so that the perimeter rim 21 and perimeter 21′ can be compressed and deformed to snap into/out of the securing means 15/circumferentially extending indenture. The main body portion 22 may be composed of the same material, or may be composed of a more rigid material. Materials contemplated include polymeric materials, rubber, and/silicone materials or combinations thereof. Strainer 20 is composed of a plurality of straining holes or apertures 25 and functions to separate liquid that comes off from the stored food. The liquid is then received and held in a bottom cavity 30 of container 11. Lid 12 is preferably aerated for circulation by way of at least one aeration aperture 12′; preferably there are a plurality of aeration apertures 12′, as illustrated in the figure.

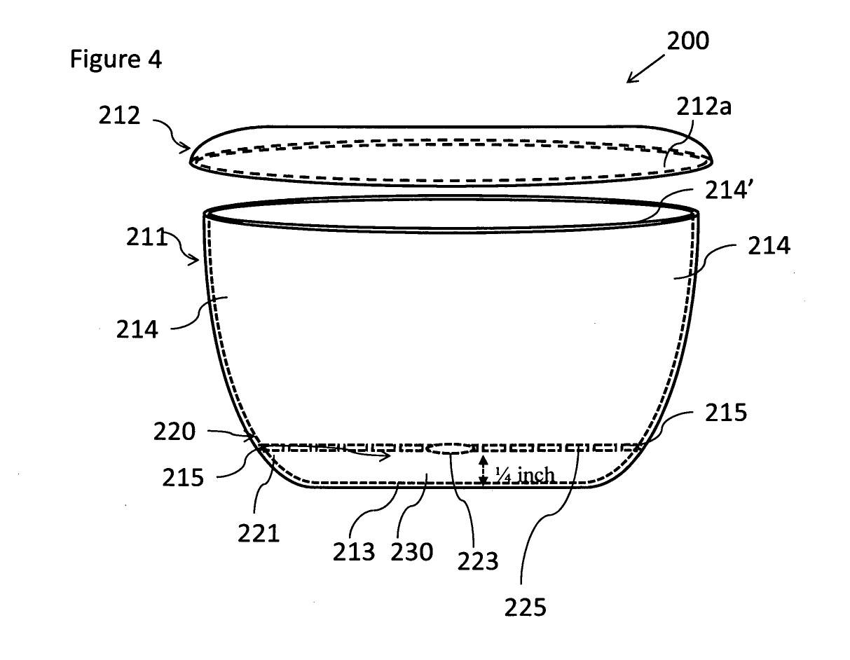

FIG. 4 illustrates an embodiment of the ‘Fresh Fit Vessel, shown generally at 200, wherein the container is constructed as a round or oval bowl, formed as a container 211 with a lid 212. Like the previous embodiment, container 211 is constructed with a bottom wall 213 and side walls 214 that terminate at a rim or top edge 214′ including a lip or closure that is adapted to be snapped into a groove 212a within lid 212 for closing the container 211. Side walls 214 include a securing means 215 adapted to fit and securing receive and house a liquid strainer divider 220. Preferably, securing means 215 in side walls 214 are constructed as a groove in at least a portion of each of the side walls 214. More preferably, the groove extends along the interior perimeter of the side walls 214 as a continuous groove circumferentially running continuously along the entire side walls 214. The securing means 215/groove is formed as a notch or groove that is adapted to receive a rim 221 of the liquid strainer divider 220. This securing means 215/circumferentially extending groove is located approximately ¼ inch from the bottom wall 213 of container 211. It is noted that the height from the bottom wall 213 of the container 211 to the securing means 215/circumferentially extending groove may be adjusted depending on the volume of the container itself as set forth hereinabove. The liquid strainer divider 220 is formed as discussed above regarding FIGS. 3a-3c.

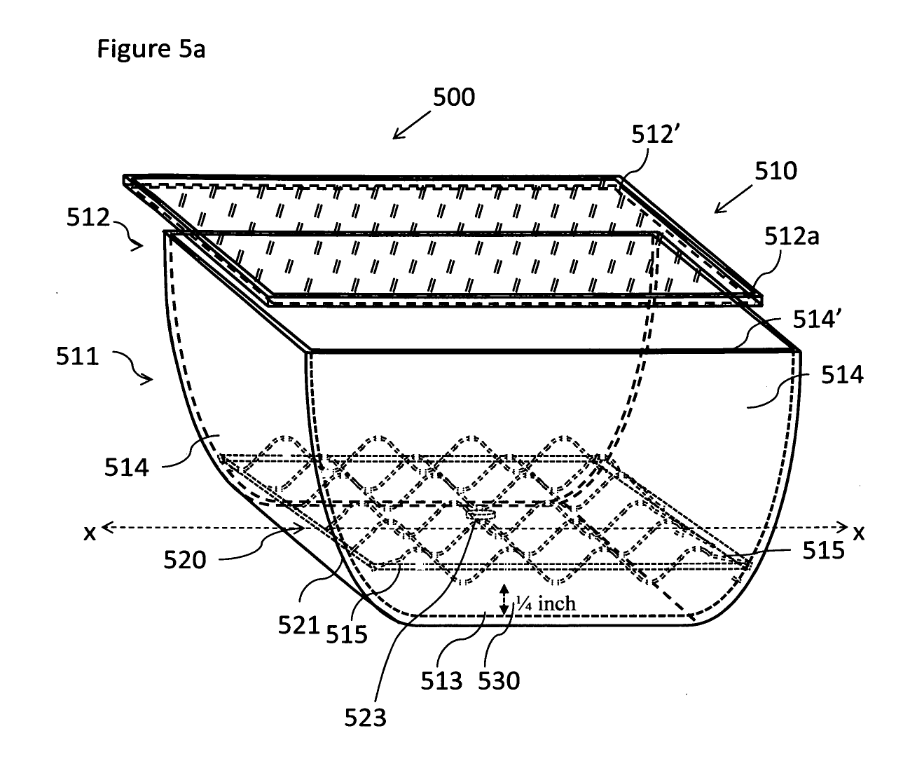

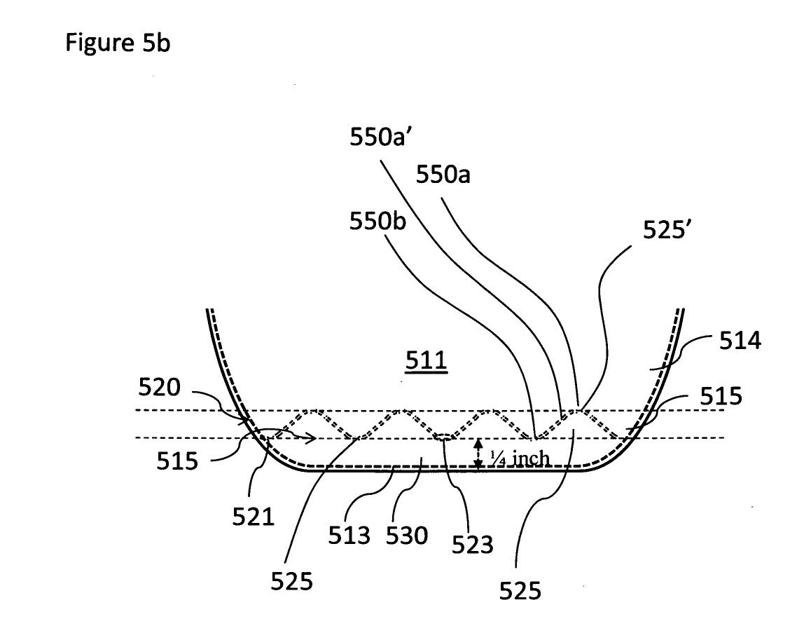

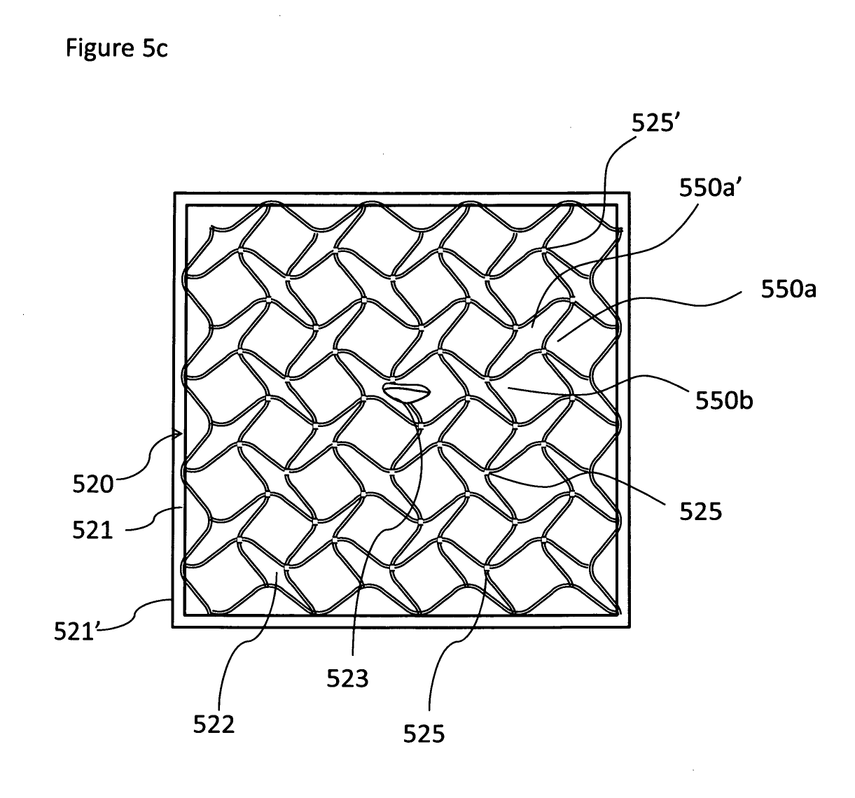

FIGS. 5a-5c illustrate another embodiment of the container with strainer device, shown generally at 500. Herein, the liquid strainer divider 520 is constructed having a plurality of shallow interconnected peaks and valleys (i.e. similar to an egg-carton construct). Container 511 has a lid 512, a bottom wall 513 and side walls 514 that terminate to a rim or top edge 515 including a lip or closure that is adapted to be snapped into a groove 512a within lid 512. Side walls 514 include a securing means 515 adapted to fit and securing receive and house a liquid strainer divider 520. Preferably, securing means 515 in side walls 514 is constructed as a groove in at least a portion of each of the side walls 514. More preferably, the groove extends along the interior perimeter of the side walls 514 as a continuous groove circumferentially running continuously along the entire side walls 514. The securing means 515/groove is formed as a notch or groove that is adapted to receive a rim 521 of the liquid strainer divider 520. A liquid strainer divider 520 is adapted to be removably received within container 511 by way of the securing means 515/circumferentially extending indenture.

The liquid strainer divider 520 is formed herein as a grate or strainer adapted to be removably received within container 511 by way of the securing means 515/circumferentially extending groove. Main body portion 522 of the divider 520 includes a removal means 523 centrally located therein. Main body portion 522 terminates at a perimeter 521′ with a perimeter rim 521. Perimeter rim 521 and perimeter 521′ thereof are snapped and received securely and tightly fit within the securing means 515/circumferentially extending groove of container 511.

Removal means 523 of strainer 520 is provided as a tab or finger hole wherein a user pulls upward thereon to remove or snap the strainer 520 from the securing means 515. In another embodiment the removal means 523 may instead be pull tabs located on or near perimeter rim 521 and/or perimeter 521′.

Preferably perimeter rim 521 and perimeter 521′ thereof are substantially flat (as opposed to the wave construct of main body portion 522) and composed of a resilient yet flexible material so that the perimeter rim 521 and perimeter 521′ can be compressed and deformed to snap into/out of the securing means 515. The main body portion 522 may be composed of the same material, or may be composed of a more rigid material. Materials contemplated include polymeric materials, rubber, and/silicone materials or combinations thereof.

Strainer 520 is formed having a plurality of interconnected shallow peaks 550a and valleys 550b. Preferably, each peak 550a is formed as a convex arched curve with sloping walls 550a′ terminating to valleys 550b that are conversely concave arched curves so as to form an interconnected waved structure (see FIG. 5b).

Preferably, each valley 550b includes at least one aperture or hole 525 therein so that liquid flows from the convex arched curve of peak 550a down sloping walls 550a′ and into valley 550b, wherein the liquid flows through aperture 525 into the bottom cavity 530 of container 511. In another embodiment, peaks 550a also include at least one aperture or hold 525′ located centrally within each peak 550a. Alternatively, sloping walls 550a′ may also include a plurality of apertures therein (not shown). Preferably sloping walls 550a′ are smooth slippery walls compelling liquid to flow and bead so as to travel downward into valleys 550b and through apertures 525 therein located.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A container with strainer divider comprising:
a. a container having a bottom wall and side walls;
b. said side walls including a securing means that is adapted to fit and securely receive and house a liquid strainer divider;
c. said liquid strainer divider having a main body portion terminating at a perimeter with a perimeter rim, said liquid strainer divider being composed of a flat sheet with at least two opposing fold lines forming wall sections and terminating at edges opposite to an aperture centrally located within said sheet;
d. said perimeter rim and perimeter of said main body portion of said liquid strainer divider being adapted to be received securely within said securing means of said container, and when inserted within said securing means said liquid strainer divider is forced to form a shallow cone shape with sloping side walls having a slope angle θ;
wherein when said liquid strainer divider is in its non-compressed form, as when it is removed from said container, it is generally a flat sheet with fold lines and wall sections laying separated or non-overlapping in relation to one another, and conversely when said liquid strainer divider is in its compressed form, as when it is inserted within said securing means within said of container, it is forced to form said shallow cone shape with sloping side walls at said slope angle θ;
wherein said liquid strainer divider is adapted to separate liquid to said bottom wall of said container as the liquid migrates down said sloping side walls through said centrally located aperture.

2. A container with strainer divider as recited by claim 1, wherein said container includes a lid capable of sealing said container shut in a closed condition.

3. A container with strainer divider as recited by claim 1, wherein said securing means is formed within said side walls and is constructed as a groove that extends along an interior perimeter of at least a portion of each of said side walls, wherein said groove is adapted to receive at least said perimeter rim of said liquid strainer divider.

4. A container with strainer divider as recited by claim 3, wherein said groove extends along said interior perimeter of said side walls as a continuous groove circumferentially running continuously and uninterrupted along said side walls.

5. A container with strainer divider as recited by claim 3, wherein said groove circumferentially extends along said side walls and is located at a distance x from said bottom wall of said container, said distance x ranging from ⅛ inch to 3 inches.

6. A container with strainer divider as recited by claim 5, wherein said distance x is about ¼ inch.

7. A container with strainer divider as recited by claim 1, wherein said strainer divider is composed of a flexible sheet having a non-friction surface or slippery plastic material that allows liquid to move freely down said sloping walls and through said aperture.

8. A container with strainer divider as recited by claim 1, wherein said strainer divider includes at least four opposing fold lines forming at least four wall sections terminating at edges and to said aperture located centrally within said sheet.

9. A container with strainer divider as recited by claim 1, wherein said slope angle θ ranges from about 10° to about 45°.

10. A container with strainer divider as recited by claim 1, wherein said liquid strainer divider includes a removal means.

11. A container with strainer divider as recited by claim 10, wherein said removal means is at least one pull tab located on said liquid strainer divider.

12. A container with strainer divider as recited by claim 10, wherein said removal means comprises said centrally located aperture and said aperture is sized and adapted to accommodate a finger for removal of said liquid strainer divider.

13. A container with strainer divider as recited by claim 1, wherein said perimeter rim and perimeter of said liquid strainer divider is composed of a resilient yet flexible material so that said perimeter rim and perimeter can be compressed and deformed to snap into/out of said securing means.

14. A container with strainer divider as recited by claim 13, wherein said main body portion is composed of a more rigid material than said perimeter rim and perimeter of said liquid strainer divider.

15. A container with strainer divider as recited by claim 1, wherein said liquid strainer divider is composed of a polymeric, rubber, and/or silicone material or combinations thereof.

16. A container with strainer divider as recited by claim 1, wherein said liquid strainer divider comprises at least one aeration aperture separate from said centrally located aperture.

17. A strainer divider comprising:
a. a liquid strainer divider having a main body portion terminating at a perimeter with a perimeter rim, said liquid strainer divider being composed of a flat sheet with at least two opposing fold lines forming wall sections and terminating at edges and to an aperture located centrally within said sheet;
b. said perimeter rim and perimeter of said main body portion of said liquid strainer divider being adapted to be received and abut against walls of a container, and when inserted within said container said liquid strainer divider is forced to form a shallow cone shape with sloping side walls having a slope angle θ.
wherein said liquid strainer divider functions to separate liquid to said bottom of said container.

18. A strainer divider comprising:
a. a liquid strainer divider having a main body portion with a plurality of closely arranged apertures having small diameters, said body portion terminating at a perimeter with a perimeter rim;
b. said perimeter rim and perimeter of said main body portion of said liquid strainer divider being adapted to be received and abut against walls of a container and said plurality of straining holes or apertures of said liquid strainer divider functioning to separate liquid to said bottom wall of said container; and
c. said liquid strainer divider having removal means centrally located therein, wherein said liquid strainer divider functions to separate liquid to said bottom of said container.

19. A strainer divider as recited by claim 18, wherein said removal means is a centrally located aperture having a larger diameter than each of said plurality of apertures.

20. A strainer divider as recited by claim 18, wherein said liquid strainer divider is formed having a plurality of interconnected shallow peaks and valleys, wherein said peaks are formed as a convex arched curve with sloping walls terminating to valleys that are conversely concave arched curves so as to form an interconnected waved structure.

21. A strainer divider as recited by claim 20, wherein said each of said valleys include at least one aperture or hole therein.

22. A strainer divider as recited by claim 21, wherein said each of said peaks include at least one aperture or hole therein.

23. A strainer divider as recited by claim 18, comprising a container, said container comprising:
i. a bottom wall and side walls;
ii. said side walls including a securing means adapted to fit and securely receive and house said strainer divider;
wherein said perimeter rim and perimeter of said main body portion of said strainer divider is removably received within said securing means of said container and said plurality of closely arranged apertures of said liquid strainer divider functions to separate liquid from food stored within said container and store said separated liquid in said bottom wall of said container.
